(19) United States
(12) Patent Application Publication
(10) Pub. No.: US 2026/0203391 A1
(43) Pub. Date: Jul. 16, 2026

(54) SIMULTANEOUS AUTHENTICATION OF EQUALS (SAE) PASSWORD IDENTIFIERS PRIVACY PROTECTION

(71) Applicant: Cisco Technology, Inc., San Jose, CA (US)

(72) Inventors: Javier Contreras Albesa, Barcelona (ES); Stephen M. Orr, Wallkill, NY (US)

(73) Assignee: Cisco Technology, Inc., San Jose, CA (US)

(21) Appl. No.: 19/447,629

(22) Filed: Jan. 13, 2026

Related U.S. Application Data
(60) Provisional application No. 63/744,820, filed on Jan. 13, 2025.

(51) Int. Cl. G06F 21/46; H04L 9/08

(52) U.S. Cl. CPC G06F 21/46; H04L 9/0861

(57) ABSTRACT

Simultaneous Authentication of Equals (SAE) password identifiers privacy protection may be provided. A client device may receive a set of password Identifiers (IDs) over an Out-of-Band (OOB) connection. Next the computing device may select, from the set of password IDs, a password ID to be seen by an authenticator, and to be applied to an SAE exchange. The computing device may then rotate across the set of password IDs for subsequent SAE exchanges.

### RELATED APPLICATION

Under provisions of 35 U.S.C. § 119(e), Applicant claims the benefit of U.S. Provisional Application No. 63/744,820, filed January 13, 2025, which is incorporated herein by reference.

### TECHNICAL FIELD

The present disclosure relates generally to providing Simultaneous Authentication of Equals (SAE) password identifiers privacy protection.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing Simultaneous Authentication of Equals (SAE) password identifiers privacy protection;

FIG. 2 is a flow chart of a method for providing SAE password identifiers privacy protection; and

FIG. 3 is a block diagram of a computing device.

### DETAILED DESCRIPTION

### OVERVIEW

Simultaneous Authentication of Equals (SAE) password identifiers privacy protection may be provided. A client device may receive a set of password Identifiers (IDs) over an Out-of-Band (OOB) connection. Next the computing device may select, from the set of password IDs, a password ID to be seen by an authenticator, and to be applied to an SAE exchange. The computing device may then rotate across the set of password IDs for subsequent SAE exchanges.

Both the foregoing overview and the following example embodiments are examples and explanatory only and should not be considered to restrict the disclosure’s scope, as described and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Simultaneous Authentication of Equals (SAE) password Identifiers (IDs), are a way to support multiple passwords or shared keys, over a same Service Set Identifier (SSID), with the possibility to have one password per device/user, or share a different passwords across different client types or policies. The Institute of Electrical and Electronics Engineers (IEEE) 802.11bi is a standard focused on restricting tracking of individual devices, and increase the privacy of IEEE 802.11 wireless networks. A privacy protection may be added to IEEE 802.11bi for SAE password identifiers by sending a new identifier after a successful authentication (e.g., during Extensible Authentication Protocol over LAN (EAPoL) 4 way handshake), on messages M3/M4 of the 4 way handshake.

The aforementioned addition may have some possible technical problems. For example, on day zero the station (i.e., client device) must send the initial password ID to the AP, before authentication. In case it fails, it will have to reuse it, so it allows for an attacker to detect it, and link to the next usage and Media Access Control (MAC) address. This may be a small window of opportunity, but it may be a leak of possible tracking data during the initial connection setup.

Another problem may be if there is a state loss of the current password ID between the station and network, it may cause the station to use an ID already replaced by the network on a previous authentication, leading to subsequent authentication failures from that point, as the user may not be aware of the current ID in use. Yet another problem may be if the station is not using Fast Roaming (FT), on every new association, the AP/Extended Service Set (ESS) must reach out to a radius server to obtain the new ID to use (one possible implementation), or it may have to assign a new ID, and update the radius server (another alternative implementation). This may increase the overall possible load to the authentication infrastructure, compared with the existing password ID mechanism, that may only need to check the ID on the first association, and cache if for subsequent roams, until the device is disconnected from network. To address these aforementioned problems, embodiments of the disclosure may provide a range of password IDs to use during SAE authentication.

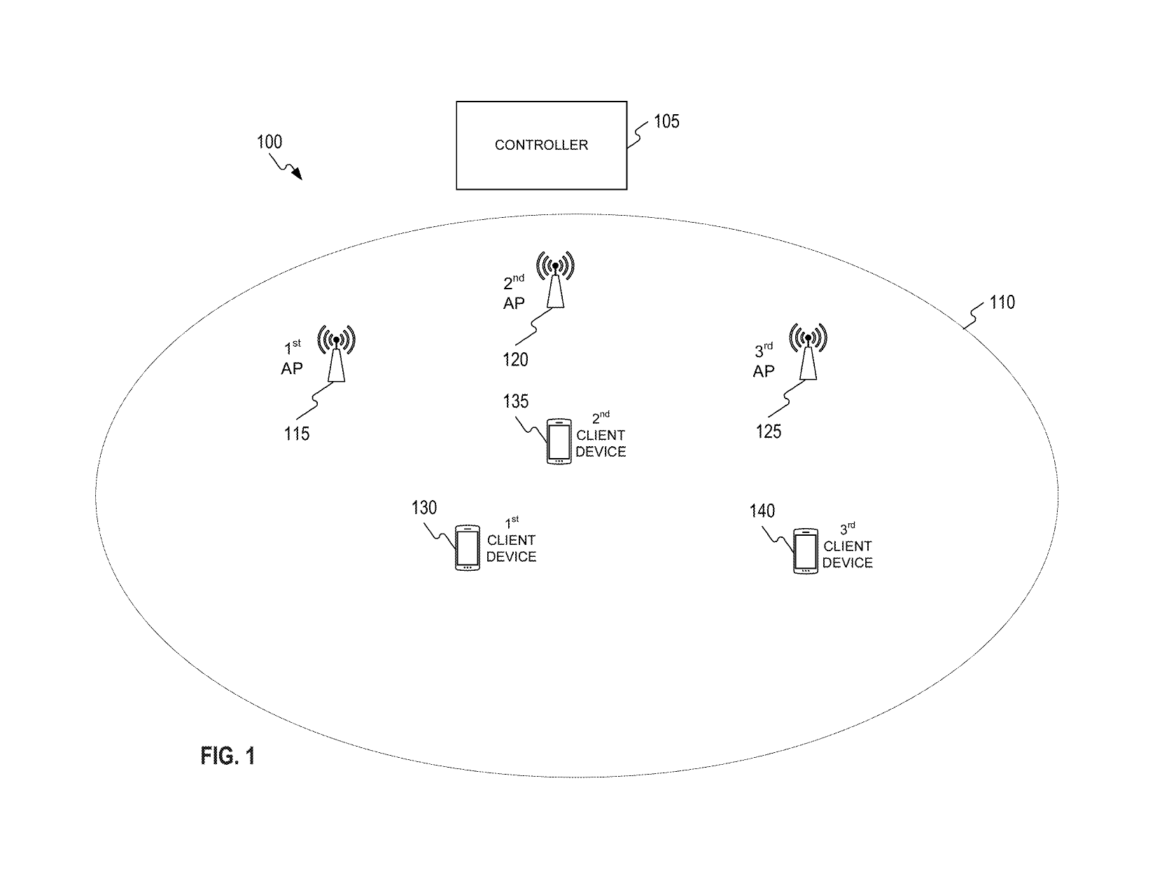

FIG. 1 shows an operating environment 100 for providing Simultaneous Authentication of Equals (SAE) password identifiers privacy protection. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three.

The plurality of APs may provide wireless network access to a plurality of client devices (i.e., Station (STAs)) as they move within coverage environment 110. The plurality of client devices may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, a vehicle, an autonomous vehicle, an Unmanned Aerial Vehicle (UAV), Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard.

The plurality of APs and the plurality of client devices may use Multi Link Operation (MLO) where they simultaneously transmit and receive across different bands (or links) and channels by establishing two or more links to two or more AP radios. These bands may comprise, but are not limited to the 2.4 GHz band, the 5 GHz band, the 6 GHz band, and the 60 GHz band. The two or more links on any given one of the plurality of client devices may be made with any one AP or with any combination of the APs.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide SAE password identifiers privacy protection.

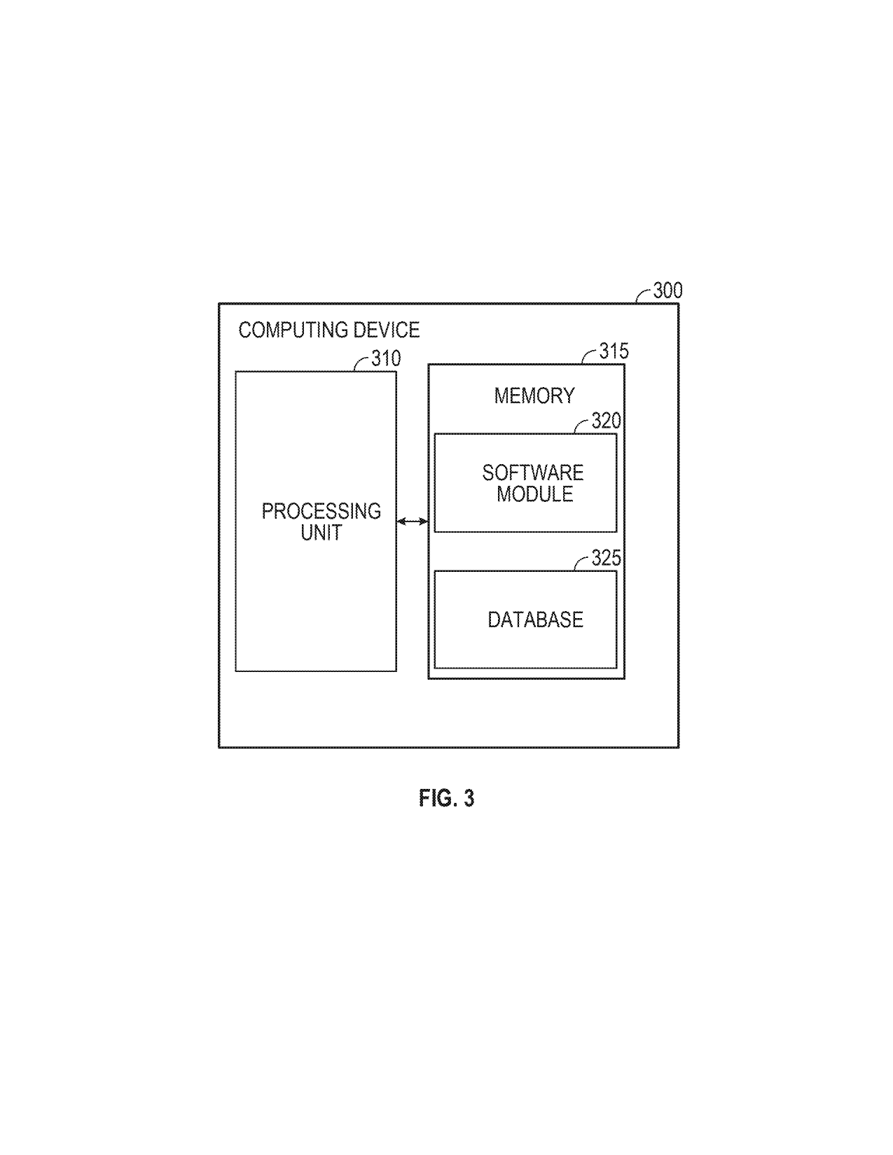

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

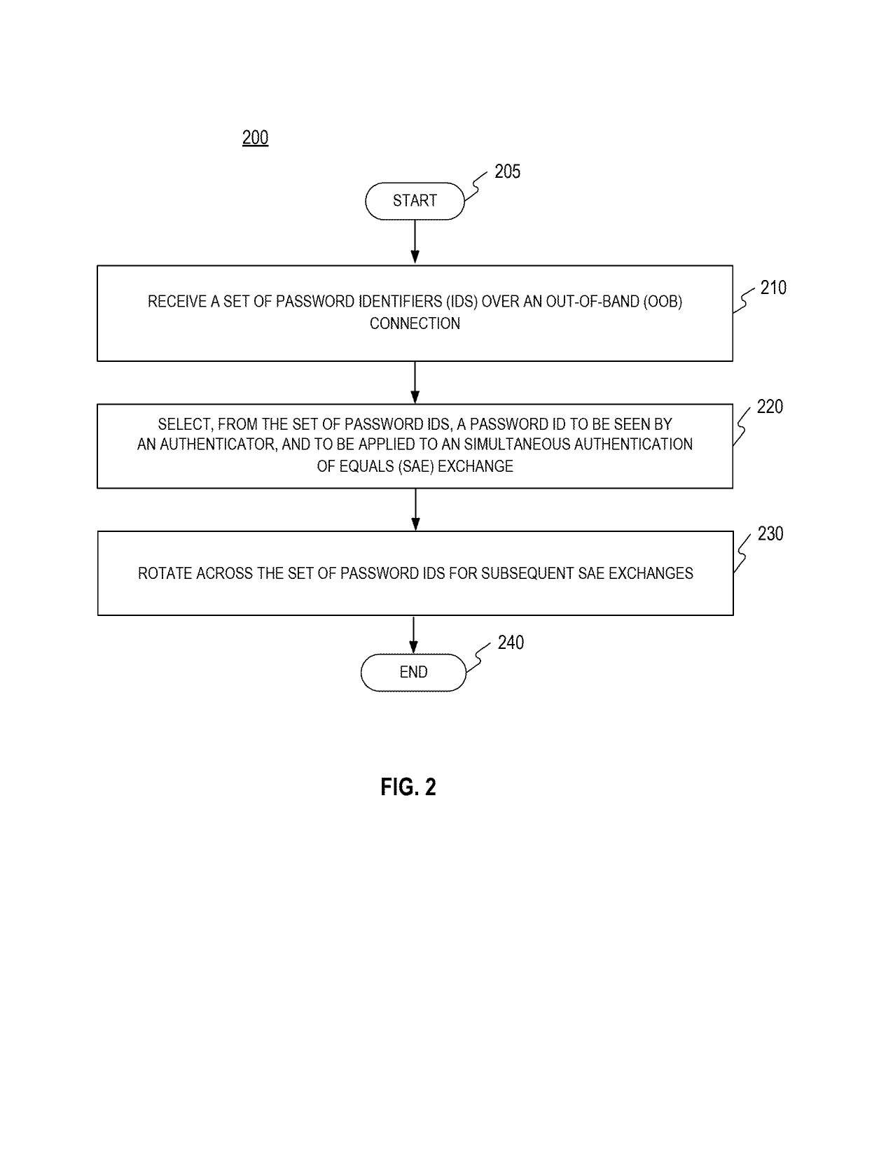

FIG. 2 is a flow chart setting forth the general stages involved in a method 200 consistent with embodiments of the disclosure for providing SAE password identifiers privacy protection. Method 200 may be implemented using first client device 130 embodied by computing device 300 as described in more detail below with respect to FIG. 3. Ways to implement the stages of method 200 will be described in greater detail below.

Method 200 may begin at starting block 205 and proceed to stage 210 where computing device 300 may receive a set of password Identifiers (IDs) over an Out-of-Band (OOB) connection. For example, the infrastructure of operating environment 100 (e.g., controller 105) may allocate a set of password IDs to each client device including first client device 130. This set of password IDs may be a range of password IDs or a list of randomly selected password IDs for example. Controller 105 may preconfigure the set of password IDs on first client device 130 by the OOB connection. The OOB connection may comprise, but is not limited to, 3G, 4G, or 5G for example. For example, a first password ID may comprise a nonce, provided by an administrator to user, OOB may be used for profile setup, then replaced with a range.

From stage 210, where computing device 300 receives the set of password IDs over the OOB connection, method 200 may advance to stage 220 where computing device 300 may select, from the set of password IDs, a password ID to be seen by an authenticator, and to be applied to an SAE exchange. For example, first client device 130 may select randomly a password ID from the set of password IDs, that may be seen by an authenticator, and used to select which password to apply to the SAE exchange . The authenticator may use the Remote Authentication Dial-In User Service (RADIUS) protocol for centralized Authentication, Authorization, and Accounting (AAA) to verify users/devices before granting network access.

Once computing device 300 selects, from the set of password IDs, the password ID to be seen by the authenticator, and to be applied to the SAE exchange in stage 220, method 200 may continue to stage 230 where computing device 300 may rotate across the set of password IDs for subsequent SAE exchanges. For example, first client device 130 may be rotating randomly across the set of password IDs range on each new SAE association. In addition, at different intervals, the network (e.g., controller 105) may trigger an update mechanism sending a new or updated set of password IDs, not just one new one to use, for maximum identity protection. Once computing device 300 rotates across the set of password IDs for subsequent SAE exchanges in stage 230, method 200 may then end at stage 240.

An embodiment consistent with the disclosure may comprise a method for providing SAE password identifiers privacy protection. The method may comprise: receiving, by a computing device, a set of password Identifiers (IDs) over an Out-of-Band (OOB) connection; selecting from the set of password IDs, by the computing device, a password ID to be seen by an authenticator, and to be applied to an Simultaneous Authentication of Equals (SAE) exchange; and rotating, by the computing device, across the set of password IDs for subsequent SAE exchanges.

Another embodiment consistent with the disclosure may comprise a system for providing SAE password identifiers privacy protection. The system may comprise a memory storage and a processing unit coupled to the memory storage. The processing unit may be operative to: receive a set of password Identifiers (IDs) over an Out-of-Band (OOB) connection; select, from the set of password IDs, a password ID to be seen by an authenticator, and to be applied to an Simultaneous Authentication of Equals (SAE) exchange; and rotate across the set of password IDs for subsequent SAE exchanges.

Yet another embodiment consistent with the disclosure may comprise non-transitory computer-readable medium that stores a set of instructions which when executed perform a method executed by the set of instructions comprising: receiving, by a computing device, a set of password Identifiers (IDs) over an Out-of-Band (OOB) connection; selecting from the set of password IDs, by the computing device, a password ID to be seen by an authenticator, and to be applied to an Simultaneous Authentication of Equals (SAE) exchange; and rotating, by the computing device, across the set of password IDs for subsequent SAE exchanges.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing Simultaneous Authentication of Equals (SAE) password identifiers privacy protection as described above with respect to FIG. 2. Computing device 300, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving, by a computing device, a set of password Identifiers (IDs) over an Out-of-Band (OOB) connection;
selecting from the set of password IDs, by the computing device, a password ID to be seen by an authenticator, and to be applied to an Simultaneous Authentication of Equals (SAE) exchange; and
rotating, by the computing device, across the set of password IDs for subsequent SAE exchanges.

2. The method of claim 1, further comprising allocating, by a controller, the set of password IDs.

3. The method of claim 2, wherein allocating the set of password IDs comprises allocating a range of password IDs.

4. The method of claim 2, wherein allocating the set of password IDs comprises allocating randomly selecting password IDs.

5. The method of claim 1, further comprising sending, by a controller, the set of password IDs over the OOB connection.

6. The method of claim 1, wherein selecting from the set of password IDs, the password ID, comprises selecting randomly from the set of password IDs, the password ID.

7. The method of claim 1, wherein rotating across the set of password IDs, for subsequent SAE exchanges comprises rotating randomly across the set of password IDs.

8. The method of claim 1, further comprising updating, by a controller, the set of password IDs.

9. The method of claim 1, wherein the computing device comprises a client device.

10. A non-transitory computer-readable medium that stores a set of instructions which when executed perform a method executed by the set of instructions comprising:
receiving, by a computing device, a set of password Identifiers (IDs) over an Out-of-Band (OOB) connection;
selecting from the set of password IDs, by the computing device, a password ID to be seen by an authenticator, and to be applied to an Simultaneous Authentication of Equals (SAE) exchange; and
rotating, by the computing device, across the set of password IDs for subsequent SAE exchanges.

11. The non-transitory computer-readable medium of claim 10, further comprising allocating, by a controller, the set of password IDs.

12. The non-transitory computer-readable medium of claim 11, wherein allocating the set of password IDs comprises allocating a range of password IDs.

13. The non-transitory computer-readable medium of claim 11, wherein allocating the set of password IDs comprises allocating randomly selecting password IDs.

14. The non-transitory computer-readable medium of claim 10, further comprising sending, by a controller, the set of password IDs over the OOB connection.

15. The non-transitory computer-readable medium of claim 10, wherein selecting from the set of password IDs, the password ID, comprises selecting randomly from the set of password IDs, the password ID.

16. The non-transitory computer-readable medium of claim 10, wherein rotating across the set of password IDs, for subsequent SAE exchanges comprises rotating randomly across the set of password IDs.

17. The non-transitory computer-readable medium of claim 10, further comprising updating, by a controller, the set of password IDs.

18. A system comprising:
a memory storage; and
a processing unit coupled to the memory storage, wherein the processing unit is operative to:
receive a set of password Identifiers (IDs) over an Out-of-Band (OOB) connection;
select, from the set of password IDs, a password ID to be seen by an authenticator, and to be applied to an Simultaneous Authentication of Equals (SAE) exchange; and
rotate across the set of password IDs for subsequent SAE exchanges.

19. The system of claim 18, wherein the processing unit being operative to select from the set of password IDs, the password ID, comprises the processing unit being operative to select randomly from the set of password IDs, the password ID.

20. The system of claim 18, wherein the processing unit being operative to rotate across the set of password IDs, for subsequent SAE exchanges comprises the processing unit being operative to rotate randomly across the set of password IDs.
